(19) United States
(12) Patent Application Publication
(10) Pub. No.: US 2009/0212020 A1
(43) Pub. Date: Aug. 27, 2009

(54) Method for Microstructuring Solid Surfaces

(75) Inventors: Kuno Mayer, Freiburg (DE); Daniel Kray, Freiburg (DE); Sybille Hopman, Mahlberg (DE); Bernd O. Kolbesen, Bad Homburg (DE)

Correspondence Address: GIBSON & DERNIER L.L.P., 900 ROUTE 9 NORTH, SUITE 504, WOODBRIDGE, NJ, 07095, US

(73) Assignee: FRA UNHOFER-GESELLSCHAFT ZUR FÖRDERUNG DER ANGEWAN, Munchen (DE)

(21) Appl. No.: 11/817,533

(22) PCT Filed: Mar. 9, 2006
(86) PCT No.: PCT/EP06/02193

§ 371 Date: Nov. 12, 2007

(30) Foreign Application Priority Data
Mar. 16, 2005 (DE) 10 2005 012 490.9
Jan. 25, 2006 (DE) 10 2006 003 604.2

(51) Int. Cl. B44C 1/22

(52) U.S. Cl. 216/94; 216/83

(57) ABSTRACT

The invention relates to a method for microstructuring solid surfaces by chemical or electrochemical etching, in which the solid surface is treated with an etching fluid with formation of intermediate products which are insoluble or low-soluble in the etching fluid. By additional use of a particle stream, these intermediate products can be removed in a simple manner. Associated herewith is the advantage that low damage microstructuring of solid bodies is made possible.

### BACKGROUND

The invention relates to a method for microstructuring solid surfaces by chemical or electrochemical etching, in which the solid surface is treated with an etching fluid with formation of intermediate products which are insoluble or low-soluble in the etching fluid. By additional use of a particle stream, these intermediate products can be removed in a simple manner. Associated herewith is the advantage that low-damage microstructuring of solid bodies is made possible.

The microstructuring of solid bodies is generally achieved in prior art by wet chemical etching. The wet chemical methods are thereby associated with masking steps, e.g. photolithography, which makes these methods very complex and time-consuming.

A further variant in prior art is based on laser structuring of the surface in a reactive atmosphere which can be gaseous or liquid. A disadvantage of the laser structuring is the focusing problem which occurs here due to the non-constant refractive index and also the limited guidance of reactands and the low expulsion rate of the reaction products.

A further variant relates to the liquid jet-guided laser machining which to date has operated with water as medium. As a result of high energy laser pulses, the result here is material vaporisation which enables material removal. However the advantage is associated herewith that the result is considerable mechanical and thermal loads or damage to the solid surface.

### SUMMARY OF THE INVENTION

Starting herefrom, it was the object of the present invention to provide a microstructuring method which is based on a damage-free chemical or electrochemical treatment and, at the same time, allows a high process rate.

According to the invention, a method for microstructuring solid surfaces by chemical or electrochemical etching is provided, in which the solid surface is treated with an etching fluid with formation of intermediate products which are insoluble or low-soluble in the etching fluid, wherein the formed intermediate products, which can only be removed with difficulty according to the methods known from prior art and which hence reduce the process rate, are removed by simultaneous or subsequent tribological treatment of the solid surface with at least one particle stream.

By means of the method according to the invention, the intermediate products, which are produced on the surface by chemical or electrochemical reaction and possibly accumulate and which as a rule are difficult to dissolve or insoluble in the etching fluid, are removed easily, which leads to a significant acceleration of the structuring method and, for removal of the intermediate products, is the speed-determining step of the structuring.

In addition, the formation of a compact passivation layer, as occurs when using the stationary etching media known from prior art, is intended to be avoided by treatment with the particle stream. The result is roughening of the solid surface by the particle stream, which makes the formation of a passivation layer difficult.

Preferably, the particle stream comprises nanoparticles, i.e. particles with a particle size in the range of 1 nm to 1 pm, particularly preferably in the range of 1 nm to 200 nm. With respect to the particle materials, all materials which permit a corresponding tribological treatment of the chosen solid body are usable. Preferred materials are hereby selected from the group consisting of silicon dioxide, aluminium oxide, in particular corundum, zirconium oxide, silicon carbide, graphite or mixtures thereof.

A further preferred variant of the method according to the invention provides that the particles are dispersed in the etching fluid or form colloidal solutions with the etching fluid.

In order to be able to remove the individual surface regions of the solid body with the particle stream, a variant according to the invention provides that the at least one particle stream is guided over the regions of the solid surface to be removed. A control device for example can be used for this purpose, said control device allowing two-dimensional removal of the solid surface. However, it is also possible as an alternative that a stationary particle stream is used whilst the solid body is moved.

Basically the particle stream according to the invention can be used in combination with all the microstructuring methods known from prior art. A preferred variant hereby provides that a liquid etching medium is used as etching fluid. This liquid etching medium is then directed towards the solid surface in the form of a liquid jet, the liquid jet being preferably laminar. The diameter of such a liquid jet is thereby preferably from 10 to 100 pm.

If the described liquid jet is used, it is particularly preferred that a laser beam is coupled to this liquid jet. The coupled laser beam can be guided then by total reflection in the liquid jet. The particles are thereby suspended preferably in the liquid etching medium and then supplied to a nozzle unit, preferably radially, the nozzle opening of which is directed towards the solid surface. This variant represents a particularly efficient possibility in that the liquid jet and particle stream are combined with each other.

According to a further preferred variant according to the invention, the particle stream can also be used during gas phase etching. This is important above all when non-volatile surface layers are produced during gas phase etching. By using the particle stream according to the invention, the etching effect can be increased locally in that the nonvolatile surface layers are removed physically during the process.

Another preferred variant according to the invention provides that the particle stream according to the invention is used in combination with electrochemical microstructuring methods. During the electrochemical etching of silicon for example, poorly-adhering and partially porous silicon dioxide is thus formed. This can be removed in a simple manner and efficiently with the help of the particle stream.

All microstructurable materials can be used as solid bodies. The solid bodies thereby preferably comprise silicon, glass, ceramic, plastic material and/or composites thereof.

According to the invention, a solid body, the surface of which is microstructurable with the method according to the invention, is likewise provided.

### BRIEF DESCRIPTION OF THE DRAWINGS

A variant of the method according to the invention is intended to be explained in more detail with reference to the subsequent FIGURE, without wishing to restrict the latter to the embodiments shown here.

FIG. 1 shows a representation of a variant of the method, which is based on electrochemical etching, according to the invention.

### DETAILED DESCRIPTION OF THE EMBODIMENTS OF THE INVENTION

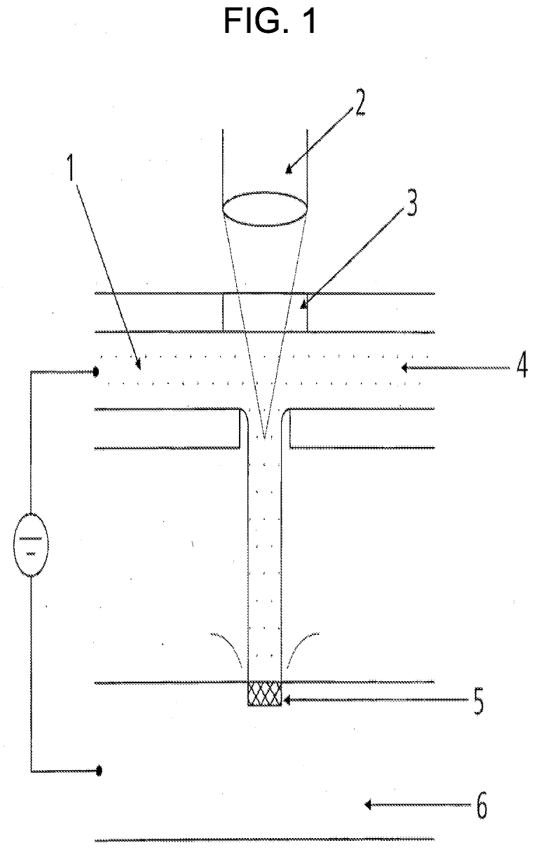

In FIG. 1, a solid body 1, e.g. silicon, is treated with a liquid jet-guided laser. Between the solid body 1 and the liquid jet 2, a direct voltage 3 is applied here. The liquid jet 2 is thereby guided through a nozzle unit 4. This has a window 5 on the side orientated away from the solid body through which the light can be coupled with a laser source 6. The growth of an anodic oxide is made possible by the construction described here. The addition of nanoparticles, e.g. zirconium oxide, to the liquid jet leads to continual removal of the oxide during the course of the process so that no compact passivation layer can form on the solid body. Without the addition of particles of this type the result would rapidly be covering of the surface with the oxide, as a result of which the reaction would come to a standstill.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for microstructuring solid surfaces by chemical or electrochemical etching, comprising:
treating the solid surface with a liquid etching medium;
forming intermediate products wherein the intermediate products are insoluble in the liquid etching medium; and
removing the intermediate products with a simultaneous or subsequent tribological treatment of the solid surface with at least one particle stream, wherein the liquid etching medium is directed towards the solid surface as a liquid jet.

2. The method according to claim 1, wherein the particles have a particle size in the range of 1 nm to 1 pm, or from 1 nm to 200 nm.

3. The method according to claim 1, wherein the particles are selected from a group consisting of silicon dioxide, aluminium oxides, corundum, zirconium oxide, silicon carbide, graphite or mixtures thereof.

4. The method according to claim 1, wherein the particles are dispersed in the liquid etching medium or form colloidal solutions with the liquid etching medium.

5. The method according to claim 1, wherein the at least one particle stream is guided over regions of the solid surface to be removed.

6. The method according to claim 1, wherein at least one stationary particle stream is used and the solid body is moved in relation to the particle stream.

7. The method according to claim 6, wherein the liquid jet is laminar.

8. The method according to claim 1, wherein the liquid jet has a diameter in a range of 10 to 100 um.

9. The method according to claim 1, wherein a laser beam is coupled to the liquid jet.

10. The method according to claim 9, wherein the laser beam is guided by total reflection in the liquid jet.

11. The method according to claim 1, wherein the particles are suspended in the liquid etching medium.

12. The method according to claim 1, wherein the solid body is selected from a group consisting of silicon, glass, ceramic, plastic material and composites thereof.
